(19) United States
(12) Patent Application Publication
(10) Pub. No.: US 2013/0117047 A1
(43) Pub. Date: May 9, 2013

(54) Method for Defeasance of Pension Scheme Risk

(71) Applicants: Timothy Lyons, Kent (GB); Jonathan Stolerman, Shipston on Stour (GB)

(72) Inventors: Timothy Lyons, Kent (GB); Jonathan Stolerman, Shipston on Stour (GB)

(73) Assignee: PENSIONS FIRST CAPITAL PARTNERS LIMITED, London (GB)

(21) Appl. No.: 13/292,287

(22) Filed: Nov. 9, 2011

(51) Int. Cl. G06Q 40/08

(52) U.S. Cl. 705/4

(57) ABSTRACT

A method of transferring risk from a pension scheme, comprising: a sponsoring entity acquiring a captive entity established to provide infrastructure to insure at least a portion of the pension scheme's liabilities; the sponsoring entity providing an amount of risk capital to the captive entity and an amount of capital to the pension scheme; the captive entity writing one or more contracts in favor of a counterparty to make payments dependent on the insured liabilities to the pension scheme members; calculating the insured liabilities to the pension scheme members; and causing an electronic payment of an amount dependent on the calculated insured liabilities to be executed to the counterparty. The captive entity may be demerged from the sponsoring entity by the sponsoring entity divesting at least a portion of the captive entity.

### TECHNICAL FIELD

The present disclosure relates to methods for risk management and risk transfer in relation to pension schemes, in particular, to defined benefit pension schemes having obligations to scheme members that are supported by sponsor entities.

### BACKGROUND

Membership of pension schemes (as they are known in the UK) or pension plans (as they are known in the US) was once commonly offered to employees of entities which acted as sponsors of the pension schemes. Those pension schemes provide a defined benefit to scheme members on retirement in the form of a legal obligation of the pension scheme to pay financial benefits of an amount contingent on a number of factors including a final salary on retirement or an average salary, an accrual rate, a duration of employment of the member by a sponsor entity, and other factors.

However, many sponsor entities of these pension schemes have come to view them as a significant financial burden as they require an investment of management time and resources to administer them. In addition, significant improvement in mortality over recent years has lead to the assets held by a pension scheme to fund future liabilities being deemed insufficient, and the pension scheme being considered to be in deficit. Recent regulatory and accounting reforms have in many jurisdictions required pension scheme deficits to be reflected on the balance sheets of their sponsor entities, and have required their sponsor entities to undertake to reduce pension scheme deficits over fixed periods by making payments into the pension scheme, which represents a real financial cost.

This, coupled with the asset price volatility seen in recent years, has caused pension schemes to have an undesirable impact on the financial health of sponsor entities, which can materially depress the share price and act as a barrier to M&A activities.

As a result, many sponsor entities have closed or are closing their pension schemes to new members and are looking for opportunities to transfer away the risks associated with these pension schemes.

### BRIEF DESCRIPTION OF THE DRAWINGS

FIG. 1 shows an example illustration of the financing of a pension scheme buyout by a third party regulated insurer.

FIG. 2 is a block diagram illustrating an example methodology for a pension scheme sponsor entity acquiring an insurer entity as a subsidiary thereof and for the issuance of a bulk annuity by the subsidiary insurer entity to buyout the pension scheme, in accordance with aspects of the present invention.

FIG. 3 shows an example illustration of the financing of a pension scheme buyout by a subsidiary insurer entity in accordance with aspects of the present invention.

FIG. 4 shows an example illustration of the financing of a deferred pension scheme buyout by an insurer entity in accordance with aspects of the present invention.

FIG. 5 shows a block diagram illustrating an example methodology for demerging a subsidiary insurer entity as shown in FIG. 2 from the sponsor entity.

FIG. 6 illustrates a flow chart of the steps of an example method of a pension scheme buyout by a subsidiary insurer entity, and the demerging thereof, in accordance with aspects of the present invention.

FIG. 7 illustrates an example system of data processing apparatus for supporting the methods of the present invention.

### DETAILED DESCRIPTION

An insurance-based solution known as a ‘buyout’ of pension scheme liabilities is offered by insurance businesses to sponsor entities as a way of completely transferring responsibility for pension scheme liabilities, and the risks associated therewith, away from the sponsor entity. Under a buyout, the insurer takes on the liabilities of the pension scheme from the scheme trustees by issuing a ‘bulk annuity’ such that it has direct responsibility for ensuring the member's benefits get paid. Buyout occurs when the insurer writes policies in the names of individual scheme members that undertake to pay all member benefits due to those members under the pension scheme rules, in return for a transfer of the pension scheme assets amounting to a buyout premium. In this way, the sponsor entity and the trustees can be fully discharged of the pension scheme liabilities, which are instead taken on by the insurer. The insurer, which operates in a regulated environment, is required to hold an amount of equity as risk capital to ensure losses can be absorbed.

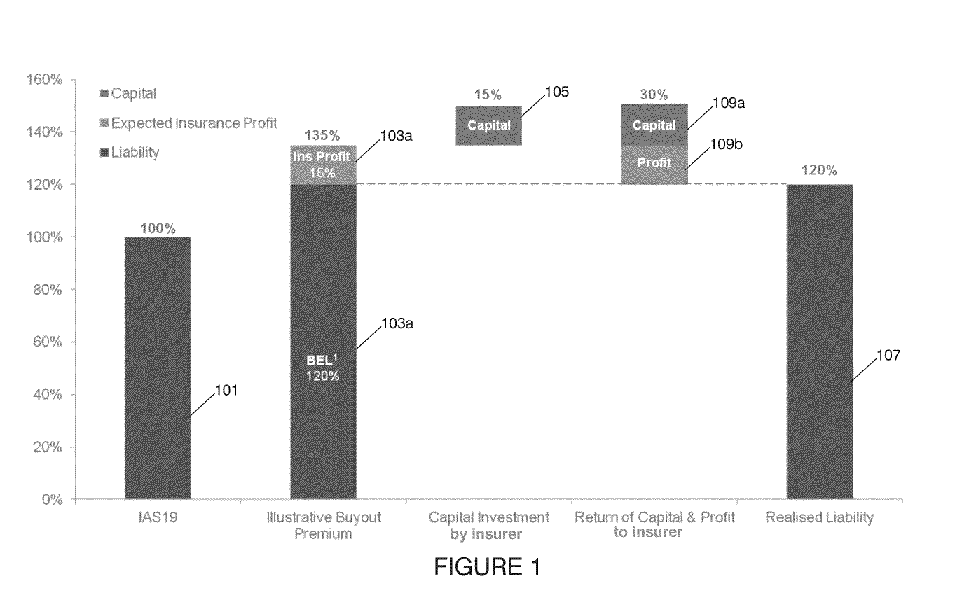

An example illustration of the financing of a buyout is illustrated in the chart shown in FIG. 1. An entity known as “ABC Plc” sponsors a pension scheme “ABC Plc Pension Scheme” that has an accounting liability, calculated under IAS 19, of £1bn, and has an asset portfolio having a value also of £1bn, such that the pension scheme is fully funded (i.e. funded at 100% of the accounting valuation of the liabilities). ABC Plc is an example manufacturing firm that wants to concentrate on its core business and avoid balance sheet exposure to pension scheme volatility.

FIG. 1 shows the economics by which a regulated insurance company will write a ‘buyout’ bulk annuity insurance contract for ABC Pension Scheme as detailed above. Taking the accounting valuation of £1bn as ‘100%’, as shown in the left-hand column 101 of the chart, the regulated insurer may price the premium for the bulk annuity as 135% of the accounting valuation of the liabilities. This premium is represented in column 103. In practice, the insurer arrives at such a valuation by calculating a ‘best estimate’ of the liabilities, which may be more conservative than the accounting valuation of the liabilities, coming in at 120% thereof (i.e. £1.2bn). This ‘best estimate’ of the liabilities as shown at 103a is valued using underlying assumptions and parameters so that they could be transferred or settled, between knowledgeable willing parties in an arm's length transaction. This includes but not limited to: using more conservative assumptions regarding return of assets leading to lower discount rates, and stronger improvement in longevity.

On top of this the insurer will add a profit margin of, say 15% in this example, in order to realise a return on the capital investment. This profit margin is shown at 103b. In order to buy the bulk annuity and effect the buyout of the pension scheme liabilities, the sponsor entity may also be required to provide to the pension scheme an additional 35% of the accounting liability (or £350 m), to cover the cost of the buyout premium. The pension scheme's assets are then exchanged in return for the insurer issuing the bulk annuity and buying out the pension scheme liabilities.

In order to meet the regulatory requirement, the insurance company must provide an additional 15% of the accounting liability as additional risk capital. This is shown in the chart of FIG. 1 at 105.

Assuming that, as the pension scheme winds up, the ‘best estimate’ of the liabilities turns out to have been correct (as illustrated by the realised liability 107), the insurer receives in return an amount 109 that allows the insurer to recover the original risk capital 109a and also a profit 109b equal to 15% of the accounting liabilities 101. The profit realised by the insurer is taken from the buyout premium 103. Of course, if the realised liability 107 is less than the ‘best estimate’ 103a, then this adds to the profit 109b of the insurer. In practice, the level of the premiums insurers ask for to effect bulk annuity buyouts of pension schemes are often seen as too expensive by many sponsor entities. In the example above, ABC Plc may decide that 35% of the accounting liabilities is too much to pay to remove the pension scheme risk. Further, many sponsor entities are uncomfortable with the insurer seeing all of the upside from the buyout in the form of the profit margin where they, the sponsor entities are providing a significant proportion of the insurers' risk capital through the bulk annuity premiums. As such, sponsor entities may be disinclined to adopt a buyout strategy.

An alternative approach offered by insurers to the buyout is the buy-in, in which the insurer writes a contract with the pension scheme trustees who administer ABC Pension Scheme, to secure future payment of selected pension scheme benefits (for example, for a selection of pension scheme members or a certain segment, e.g. 50%, of the benefits). The buy-in insurance contract is effectively held as an asset of the pension scheme to help meet scheme liabilities for the selected benefits, achieving a partial risk transfer. However, responsibility for management and administration of the pension scheme is not transferred away from ABC Pension Scheme, which continues to be responsible for payments to scheme members, albeit with added certainty over pensioner costs. The insurance premium for a buy-in contract is nevertheless calculated in a similar manner to that of buyout contracts, and as such, they suffer from the same problem of being perceived to be too expensive, and to lock out the upside from ABC Plc in favour of the insurer only.

The present invention provides a way of facilitating pension scheme risk transfer using buyout or buy-in insurance, in a way in which the sponsor entity can have more control over the risk transfer, lower costs, and can realise some of the upside from the risk transfer process.

Thus, viewed from one aspect, the present invention provides a method of transferring risk from a pension scheme having obligations to a plurality of members, comprising: a sponsor entity of the pension scheme providing an equity investment in an insurer entity established to provide infrastructure for insuring at least a portion of the pension scheme's liabilities to a portion of its members; the sponsor entity providing an amount of capital to the pension scheme to capitalise the pension scheme to an amount of an insurance premium; the insurer entity writing one or more contracts in favour of a counterparty to make payments dependent on the insured liabilities to the pension scheme members in exchange for the insurance premium; and operating data processing apparatus to calculate the insured liabilities to the pension scheme members and to cause an electronic payment of an amount dependent on the calculated insured liabilities to be executed to the counterparty.

The insurer entity may be initially acquired as a subsidiary of the sponsor entity of the pension scheme. The sponsor entity may first form a holding company, and the holding company may itself acquire the insurer entity.

The method may further comprise: demerging the insurer entity from the sponsor entity after the writing of the one or more contracts by the sponsor entity divesting at least a portion of the insurer entity.

The divestment of at least a portion of the insurer entity by the sponsor entity may include: a. offering shares or share options in the insurer entity first to shareholders of the sponsor entity; b. offering shares in the insurer entity to investors in the market via an initial public offering or private placement; c. the sponsor entity selling the insurer entity to a third party; d. spinning-off the insurer entity.

The step of writing one or more contracts may include the insurer entity writing a contract in favour of the pension scheme trustees. The contract may represent a buy-in in respect of one or more pension scheme members.

Alternatively, the step of writing one or more contracts may include the insurer entity writing respective contracts each in favour of a different pension scheme member. The contracts together may represent a buy-out in respect of all of the pension scheme members.

The method may further comprise: the insurer entity receiving deferred insurance premiums at intervals after the writing of the one or more contracts, to make up a deficit in the insurance premium paid initially by the pension scheme. The method may further comprise: funding at least part of the deferred insurance premiums from returns on the pension scheme's and the sponsor entity's equity investments in the insurer entity.

The insurer entity may be a regulated insurer.

The insurer entity may be not consolidated in the financial statements of any of its equity investors.

The method may further comprise performing the above-described risk transfer method in relation to the insurer entity a plurality of times such that the insurer entity is contracted to make payments to counterparties dependent on the liabilities of a plurality of pension schemes. The method may further comprise offering shares in the insurer entity having a ring-fenced exposure to the risks of one of the plurality of pension schemes.

Viewed from another aspect, the present invention provides a method of transferring risk from a pension scheme having obligations to a plurality of members, comprising: an entity having one or more contracts written in favour of a counterparty to make payments dependent on the liabilities to the pension scheme members; operating data processing apparatus to calculate the liabilities to a one or more of the plurality of members and to cause an electronic payment of an amount dependent on the calculated liabilities to be executed to the counterparty; wherein the entity is a subsidiary insurer entity of a sponsor entity of the pension scheme; the method further comprising demerging the subsidiary insurer entity from the sponsor entity.

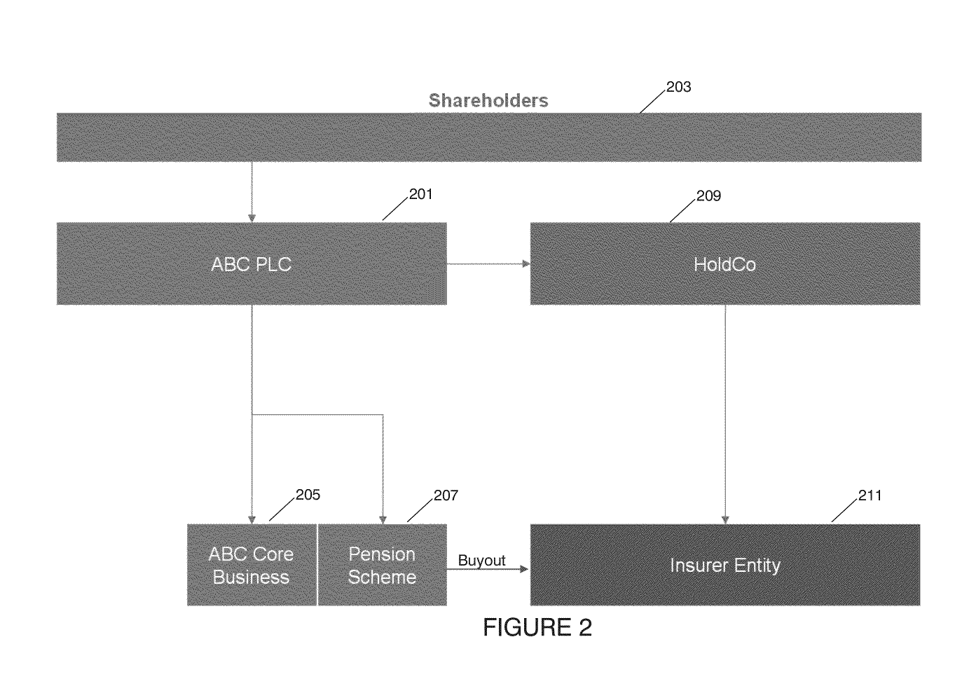

An example of the arrangement of a pension scheme buyout by the issuance of a bulk-annuity by an insurer entity in accordance with aspects of the invention will now be described with reference to FIG. 2.

FIG. 2 shows a block diagram illustrating ABC Plc 201, which is supported by shareholders 203, holding shares in ABC Plc 201. Underneath ABC Plc 201 sits ABC Core Business 205, which operates the manufacturing business of the group, and ABC Pension Scheme 207, which operates the pension scheme, using proceeds from its £1bn assets to fund the liabilities to pension scheme members.

To transfer risk away from ABC Pension Scheme 207, ABC Plc 201 forms a holding company HoldCo 209 as a wholly owned subsidiary of ABC Plc 201. After formation, HoldCo 209 itself acquires another entity Insurer Entity Ltd 211, a wholly owned subsidiary of HoldCo 209 which is itself a wholly owned subsidiary of ABC Plc 201. In embodiments, HoldCo 209 may be omitted and ABC Plc 201 may acquire Insurer Entity Ltd 211 directly as a subsidiary.

Insurer Entity Ltd 211 may have been established by a third party to provide the infrastructure to insure ABC Pension Scheme's liabilities to its members. For example, Insurer Entity Ltd 211 may be authorised by the financial regulators of that jurisdiction to be a regulated insurer. Insurer Entity Ltd 211 may have appropriate risk management platforms to receive data relating to the pension scheme membership, price liabilities, price risk, write insurance policies and make payments to counterparties, etc. The PFaroe™ platform, available from Pensions First Analytics Limited, of London, United Kingdom, may provide a suitable risk management platform for the operations of Insurer Entity Ltd 211.

Analytics have already been performed in relation to the membership of ABC Pension Scheme 207 by importing pension scheme data and, for example, projecting the member's expected mortality and liabilities, to determine a best estimate of the liabilities as a present value. In the case of ABC Pension Scheme 207, this is 120% of the accounting valuation of the liabilities.

Insurer Entity Ltd 211 is then capitalised by ABC Plc 201 to reach an amount of risk capital required by the authorities to support Insurer Entity Ltd 211 in buying out ABC Pension Scheme's liabilities. In the example above, this capitalisation is also equal to 15% of the accounting valuation of the liabilities. The total capitalisation in this instance is therefore 30% of the accounting valuation of the liabilities, of which half (i.e. 15% of the accounting valuation of the liabilities) is provided in the form of equity capital.

In the example shown in FIG. 2, ABC Pension Scheme 207 is then provided by ABC Plc 201 with an amount of capital to fund ABC Pension Scheme 207 to an amount equal to the buyout insurance premium. In the example above, in view of ABC Pension Scheme 207 being fully funded and the buyout premium being 135% of the accounting liabilities, the buyout funding provided by ABC Plc 201 to ABC Pension Scheme 207 is 35% of the accounting liabilities.

However, as ABC Plc 201 has control of the insurer Insurer Entity Ltd 211 that will buy out the pension scheme liabilities, ABC Plc 201 has some control over the buyout premium and can reduce it relative to that which would be paid to a third party insurer. For example, instead of ABC Pension Scheme 207 paying a buyout premium of 135% to Insurer Entity Ltd 211, ABC Plc may decide instead that a buyout premium of only 125% is to be paid. The amount of risk capital that is required to support Insurer Entity Ltd 211, however, remains the same, and so an additional amount of equity must be provided to support Insurer Entity Ltd 211 to compensate for the reduction in the buyout premium. This pricing of the insurance premium affords control of the cost of the buyout for the sponsor entity.

At this point, Insurer Entity Ltd 211 performs a buy out of ABC Pension Scheme 207 in return for the buyout premium (i.e. assets worth 135% of the accounting liabilities in this case), and takes direct responsibility for ensuring all of the pension scheme member's benefits get paid. It does this by writing individual contracts with each scheme member such that the ABC Plc 201 and ABC Pension Scheme 207 are completely defeased of their liabilities to the pension scheme members. Instead, Insurer Entity Ltd 211 is operated as a regulated insurer that makes payments to scheme members under the bulk annuity contracts on the basis of the proceeds from assets held.

Insurer Entity Ltd 211 is, however, a wholly owned subsidiary of ABC Plc 201 and is consolidated in ABC Plc's group financial statements.

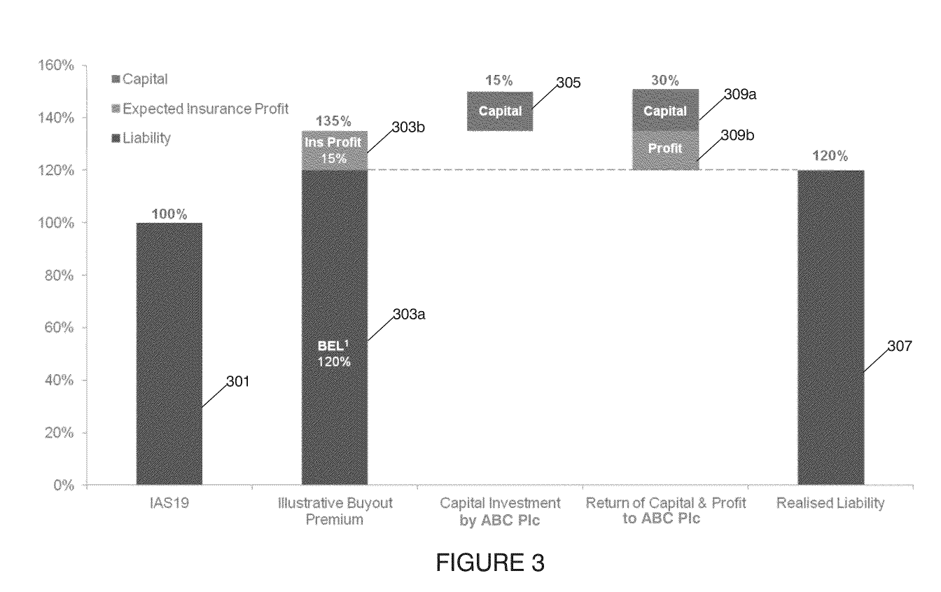

In this respect, referring to FIG. 3 which shows the financing of the buyout in accordance with aspects of the invention, if ABC Plc 201 were to hold on to Insurer Entity Ltd 211 until the pension scheme is wound up and run off, assuming the realised liability 307 is once again 120% of the accounting liabilities 301 (i.e. the ‘best estimate’ 303a turned out to be correct), then ABC Plc would see a return 309 of capital 309a and profit 309b amounting to 30% of the accounting liabilities 301. As a result, the net cost of the buyout to ABC Plc 201 will have been 120% of the accounting liabilities. This is 15% of the accounting liabilities less than if the liabilities had been bought out by a third party insurer. This reduction in cost provides a significant attraction to sponsor entities wanting to defease their pensions risks in an affordable way.

To avoid ABC Plc's investment in Insurer Entity Ltd 211 being reflected in the consolidated financial statements of ABC Plc 201, and not being consolidated at all, the ownership of equity providing the risk capital to support Insurer Entity Ltd 211 could be split between at least three parties with no one party having a majority interest in Insurer Entity Ltd. For example, the 15% risk capital described above could be split three ways between ABC Plc 201, the Pension Scheme 207 itself, and third party investors, for example, shareholders 203, each providing 5% of the equity for the risk capital. In this case, for a buyout premium of 135% of the accounting liabilities and a risk capital equity investment of 5% of the accounting liabilities by both ABC Plc 201 and ABC Pension Scheme 207, the net cost of the buyout to ABC Plc would be 125% of the accounting liabilities (assuming again that the best estimate of 120% of the accounting liabilities is realised). In this way, Insurer Entity Ltd 211 would not be a subsidiary entity and would not be consolidated in the group financial statements of any of its equity investors.

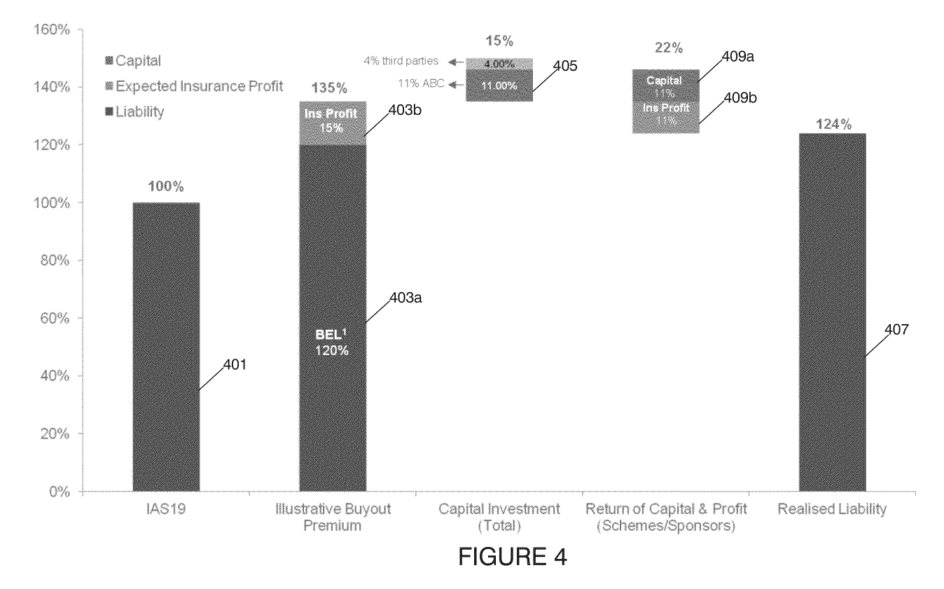

Rather than the full amount of the buyout premium being paid at the outset, the deal can instead be confirmed with the terms of the buyout being locked-in with an initial premium being funded in exchange for substantially all of the available pension scheme assets, with any deficit in the buyout premium being later made up by deferred insurance premiums paid periodically over time. Financing for the buyout may be provided by the insurer entity. Under the terms of the buyout any credit risk exposure in the deficit financing can be immunized by an agreement that, should default occur, the obligations of the insurer under the buyout would be scaled back to a level commensurate with the amount of insurance premiums paid by the pension scheme until the time of the default. With such a low credit risk achievable, the financing terms of the deferred buyout provided by the insurer can be favourable. Referring to FIG. 4, which shows the financing of a deferred buyout in accordance with aspects of the present invention, ABC Pension Scheme 207 provides an initial premium of the assets equal to 95% of the accounting liabilities 401 and risk capital 405 amounting to 5% of the accounting liabilities. A further 6% of the accounting liabilities is provided by the sponsor entity, ABC Plc 201, as risk capital 405 with third party investors providing the remaining 4% of the accounting liabilities as risk capital 405. Thus ABC Pension Scheme 207 and ABC Plc 201 together provide 11% of the accounting liabilties as risk capital 405, and yet as neither party is a majority shareholder or holder of a controlling interest in the insurer, the insurer entity is in this case not consolidated in ABC's group financial statements. This structure removes the volatility of the pension scheme from ABC Plc's balance sheet. The remaining deficit in the buyout premium, which amounts to 40% of the accounting liabilities, is financed by the insurer. The terms of this financing are, however, competitive as the credit risk exposure of the financing to a default of ABC Plc 201 can be immunized by terms written in to the buyout agreement scaling back the obligations of the insurer under the buyout to a level commensurate to the amount of the total buyout premium received. In the example shown in FIG. 4, the insurer finances the buyout premium shortfall of 40% of the accounting liabilities by agreeing with ABC Pension Scheme 207 to receive annual payments over an agreed period of time at an agreed interest rate If the realised liability 407 turns out to be equal to the best estimate of the liabilities 403a, then in return for the 11% risk capital investment, ABC Plc 201 receives a return 409 on capital 409a and profit 409b amounting to 22% of the accounting liabilities. Thus the buyout represents a net cost of 124% to ABC Plc 201, 11% less than the cost of the buyout premium payable to a third party insurer. However, the deferred buyout arrangement offers a facility by which pension scheme surpluses, if any, can be clawed back by the sponsor entity after the buyout has been effected. For example, if, after having received capital from the sponsor entity for a period of time before the buyout, ABC Pension Scheme 207 is actually overfunded and at some point after the buyout a surplus is seen, then this surplus can be realised by the value of ABC's equity investment in the insurer increasing, which can be used to offset or accelerate the end of the payments under the deferred premiums financing arrangement.

However, as ABC Plc 201 is a manufacturing business with little desire to have any exposure to or responsibility for running an insurance business and a desire instead to concentrate solely on ABC Core Business 205, ABC Plc 201 may instead decide to ‘demerge’ HoldCo 209 and with it Insurer Entity Ltd 211 so that it no longer has any connection to, or risk exposure to, the liabilities of the ABC Pension Scheme 207 to its members. This demerger may happen together with the buyout effectively at the same time and in the same deal, so that the acquisition, buyout and demerger appear instant.

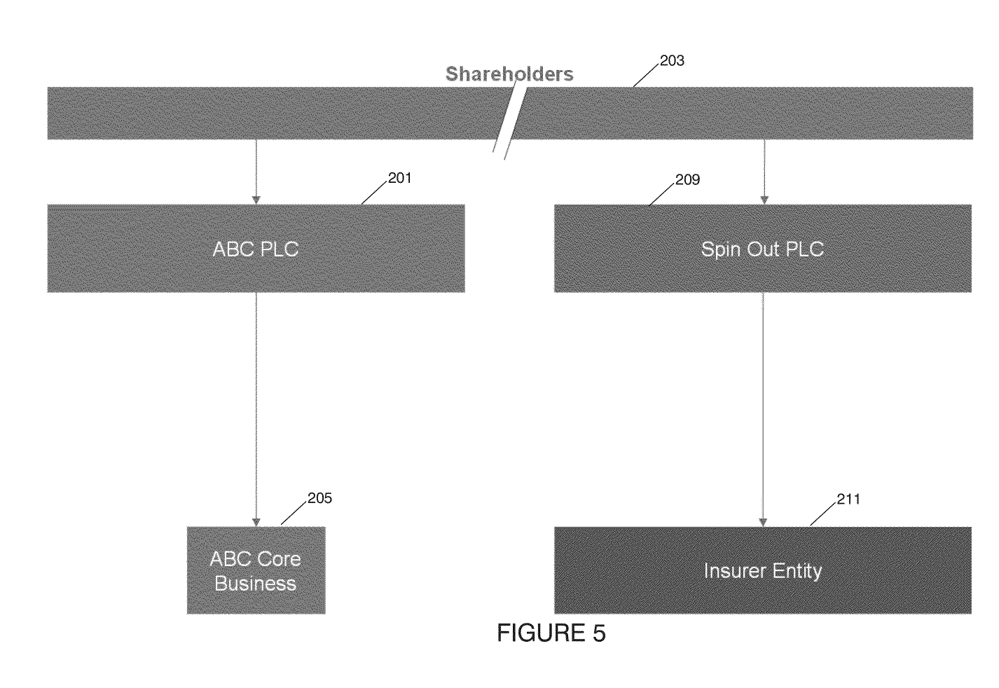

Demerger may be achieved by way of a spin-off by ABC Plc 201 offering a right to buy shares in HoldCo 209 to its shareholders 203. Such a demerger is illustrated in FIG. 5. The pricing of the shares to raise the requisite regulatory risk capital, and the pricing of the buyout premium paid by ABC Pension Scheme 207 (funded in part by ABC Plc 201) determine the cost of the transaction to ABC Plc 201 and any uplift the shareholders 203 see on exercising their rights. For example, ABC Plc may decide that the buyout premium should be 125% of the accounting liabilities, and may fund the buyout by providing an additional 25% of the accounting liabilities to ABC Pension Scheme 207. The remaining 25% of the accounting liabilities making up the risk capital requirement may be raised through the spin-out and issuing of shares. This would represent an uplift in value of 30%/25% to shareholders, and so this would be an attractive proposition. In addition, the total cost of the buyout to ABC Plc would be 125%, i.e. 10% cheaper than a buyout from a third party insurer.

At spinning out, the shareholders 203 may choose to participate in a profitable insurance company offering stable spread-based returns and future growth by holding on to their shares in HoldCo 209. Alternatively, the shareholders 203 may choose to sell their rights in HoldCo 209 and to realise value.

Instead of demerging HoldCo 209 by way of a spin-off, HoldCo 209 may be demerged by issuing shares in HoldCo 209 by an initial public offering via an exchange or private placement, and not offering rights only to shareholders 203. The shareholders 203, in buying these shares, cause HoldCo 209 and Insurer Entity Ltd 211 to be demerged from ABC Plc 201. In this way, HoldCo becomes Spin Out Plc 209 (see FIG. 5). Alternatively, ownership of HoldCo 209 and Insurer Entity Ltd 211 could be sold directly to a third party.

However the divestment of ABC Plc's interests in HoldCo 209 and Insurer Entity Ltd 211 insurance business happen, ABC Plc's holding of ownership in the insurance business falls to less than a majority share and so the insurance business does not have to be consolidated in the group financial statements of ABC Plc 201.

While the insurer entity may have initially been established and acquired as a subsidiary entity of a particular sponsor entity, then spun off after buyout to achieve a listing with attendant liquidity, the insurer may thereafter repeat the buyout process for another pension scheme by the sponsor entity performing the above-described method of investing in the insurer entity but without the insurer entity becoming a subsidiary of that sponsor entity. In this way, the insurer entity can be contracted to make payments to counterparties dependent on the liabilities of a plurality of pension schemes and thus have risk exposure to a plurality of pension schemes. To allow pension schemes and sponsor entities to invest in the insurer entity but only be exposed to the risks of a particular pension scheme, the insurer entity may offer shares having a ring-fenced exposure to the risks of that particular pension scheme. The insurer entity may be established having a cell structure to ensure this ring-fencing of collateral. Such mechanisms of providing risk exposure through investment to only a particular pension scheme may be consistent with the corporate governance of the scheme and the sponsor entity. For example, after buyout of ABC Pension Scheme's liabilities and spin-off, an insurer entity may write another one or more contracts to transfer risk away from another pension scheme, such as performing a buyout, a deferred buyout or a buy-in of at least some of XYZ Pension Scheme's liabilities. However, XYZ's Pension Scheme's sponsor entity may wish to invest in the insurer entity only by buying shares in the insurer entity that have risk exposure to XYZ Pension Scheme's liabilities. Alternatively, or in addition, XYZ's Pension Scheme's sponsor entity may choose to diversify exposure by investing in non-ringfenced shares in the insurer entity to also gain exposure to the risks of ABC Pension Scheme's liabilities comingled with the risks of XYZ Pension Scheme's liabilities.

In addition, as the insurer entity then goes on to perform more buyouts of other pension schemes, the capital required to support these deals is only drawn at the time of each transaction, rather than being raised in advance. This represents an efficient use of capital.

Transferring pension scheme risk to an insurer entity that is then demerged in the above way is enabled by the realisation that corporate pension schemes can be run as a profitable business in a regulated environment, and that material value is provided for shareholders in having the right to invest in the demerged insurance business. This also allows pension scheme liabilities to be removed from the sponsor entity's overall responsibility, removing the attendant risk and volatility, and allowing the sponsor entity to concentrate on the core business. Investment in the insurer entity by the pension scheme, sponsor entity and third party investors provides a means of achieving pensions risk transfer in a way that creates a unique alignment of interests between these parties.

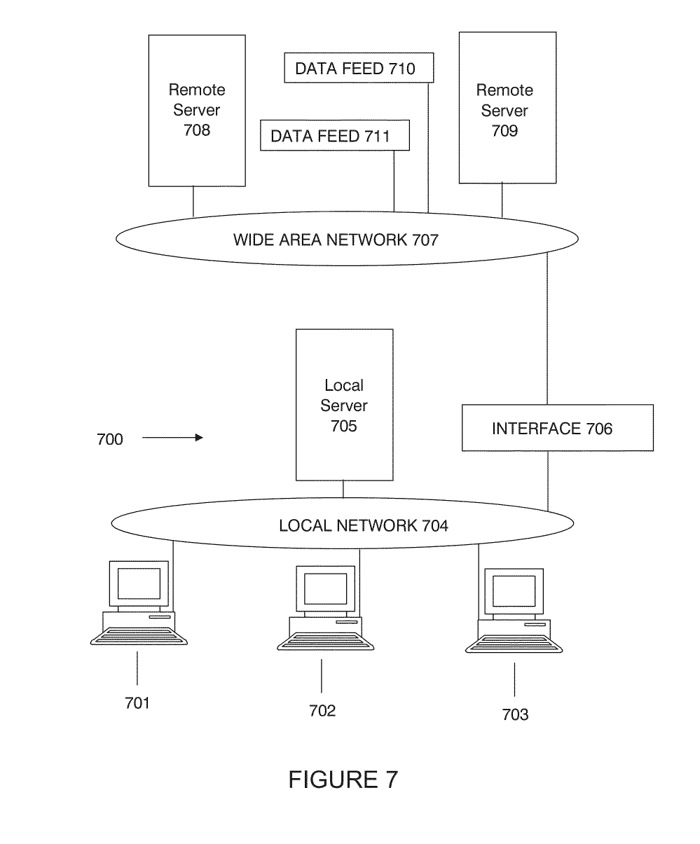

FIG. 7 illustrates a data processing system 700 that supports a risk management system for use in carrying out methods in accordance with the invention. At a local site there are personal computers 701, 702 and 703, which are interfaced to a local network 704, and a local server 705 which is also interfaced to the local network 704. Data can be stored on the local server 705 and/or the personal computers 701, 702, 703. Data processing can be carried out by the local server 705 and/or the personal computers 701, 702, 703. The local server 705 and/or the personal computers 701, 702, 703 may be configured by software to carry out one or more steps of methods in accordance with the invention. The local network 704 is provided with an interface 706 to a wide area network 707, so that the local server 705 and the personal computers 701, 702, 703 communicate with the wide area network. Remote servers 708 and 709 are also connected to the wide area network, so that data held by the remote servers can be made available to local server 705 and/or the personal computers 701, 702, 703. The remote servers can receive data from data feeds 710 and 711 also connected to the wide area network 707, which provide data such as mortality statistics, pension fund statistics and so forth. This basic data is processed by the remote servers 708 and 709 so as to provide data which is used by the local server 705 and the personal computers 701, 702, 703 in carrying out the methods in accordance with the invention. Personal computers 701, 702 and 703 may, together with local server 705, support the risk management system for performing calculations of the present values and future cash flow projections of pension scheme liabilities and assets. For example, data feed 710 may represent scheme member data that is used by personal computers 701, 702 and 703 and local server 705 to calculate liabilities, price insurance premiums, quantify risk, and determine payment amounts to be paid to counterparties to insurance contracts. Personal computers 701, 702 and 703 may, together with local server 705, effect electronic payments to counterparties by communicating with remote server 708, which may be usable to carry out financial transactions with scheme members. Of course, the risk management and electronic payment functions described above may be performed at remote servers that perform calculations under control of one or more local personal computers transmitting instructions over a network such as the internet. The remote servers may receive and process data, and transmit data representing the results of this processing to one or more local personal computers. Other suitable alternative arrangements for implementing the methods of the present invention are of course possible. The risk management system supported by data processing system 700 may analyse scheme member data to determine and project liabilities and risks in accordance with methods described in US Patent Publication No. 2010/0131425. An example risk management platform usable in the context of the present invention is PFaroe, available from Pensions First Analytics Limited, of London, United Kingdom.

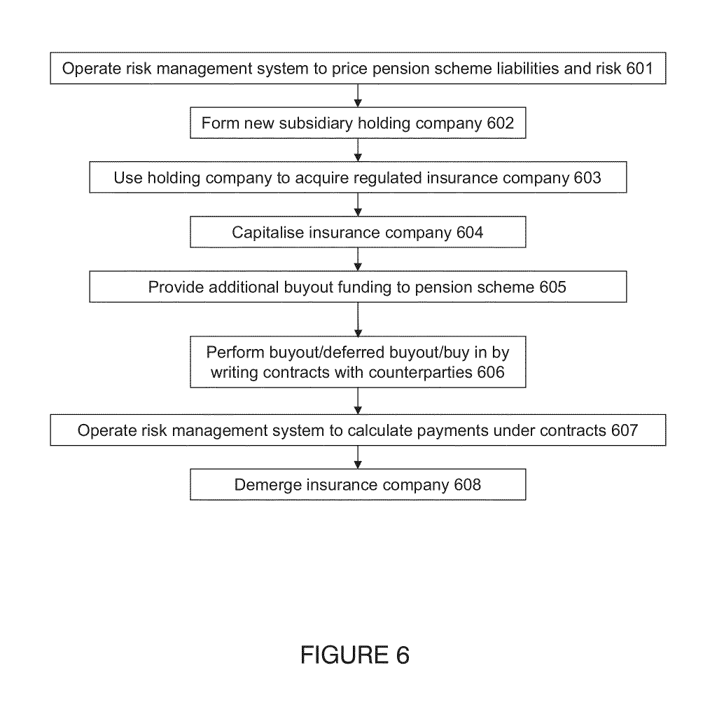

FIG. 6 shows a flow chart illustrating the process for conducting a full buyout and demerger process for ABC Pension Scheme 205. At step 601, the risk management system, such as that described above in relation to FIG. 7, is operated to receive data relating to the pension scheme membership and liabilities and to price the liabilities and risk of ABC pension scheme in order to determine a best estimate for the liabilities 303a, and an amount of regulatory risk capital 305 required to support those liabilities. The risk management system may also be operated to receive data relating to assets held by ABC Pension Scheme 205 and to calculate a net asset value of those assets. On the basis of these determinations, an amount of a buyout premium is determined.

At step 602, ABC Plc 201 forms a holding company, HoldCo 209 and at step 603 uses HoldCo 209 to acquire a regulated insurer entity that has been established to provide the infrastructure to operate a buyout insurance business, in this case, Insurer Entity Ltd 211. The use of a holding company may be omitted and ABC Plc 201 may instead acquire the regulated insurer entity directly. The regulated insurer entity may, for example, support the risk management system described in relation to FIG. 7 for calculating liabilities, writing insurance contracts and processing received data to make payments under those contracts with the counterparties.

At step 604, the regulated insurer entity, Insurer Entity Ltd 211 is capitalised by one or more investors to meet the risk capital requirement. ABC Plc 201 will typically provide at least some of this risk capital.

At step 605, ABC Plc 201 then provides buyout funding to ABC pension scheme 207 to contribute to finance the buyout premium.

At step 606, the regulated insurer Insurer Entity Ltd 211 writes a bulk annuity made up of contracts in favour of each member of ABC Pension Scheme 207 to exchange the liabilities of ABC Pension Scheme 207 with assets contributing towards the buyout premium. A deficit in the buyout premium may be financed by deferred premiums received from ABC Plc 201 after the buyout is completed.

At step 607, the risk management system is operated periodically to assess the liability to the pension scheme members and to determine the amount of payments to the counterparties under the buyout contracts.

At step 608, in this instance, the regulated insurer Insurer Entity Ltd 211 is demerged from the sponsor entity ABC Plc 201 by spinning out Insurer Entity Ltd 211 by offering the shareholder of ABC Plc 201 a right to purchase shares in Insurer Entity Ltd 211. After demerger, all exposure to the liabilities, risk and volatility of ABC Pension Scheme 207 has been transferred away from ABC Plc 201 to a publicly owned regulated insurer entity that operates as a profitable insurance business.

The assets held by Insurer Entity Ltd 211 may be managed by a separate asset management entity (not shown), and the risk exposure of Insurer Entity Ltd may be reinsured by one or more reinsurance entities (not shown).

What is claimed is:

1. A method of transferring risk from a pension scheme having obligations to
a plurality of members, comprising:
a sponsor entity of the pension scheme providing an equity investment in an insurer entity established to provide infrastructure for insuring at least a portion of the pension scheme's liabilities to a portion of its members;
the sponsor entity providing an amount of capital to the pension scheme to capitalise the pension scheme to an amount of an insurance premium;
the insurer entity writing one or more contracts in favour of a counterparty to make payments dependent on the insured liabilities to the pension scheme members in exchange for the insurance premium; and
operating data processing apparatus to calculate the insured liabilities to the pension scheme members and to cause an electronic payment of an amount dependent on the calculated insured liabilities to be executed to the counterparty.

2. A method as claimed in claim 1, wherein the insurer entity is initially acquired as a subsidiary of the sponsor entity of the pension scheme.

3. A method as claimed in claim 2, wherein the insurer entity being acquired as a subsidiary of the sponsor entity includes the sponsor entity first forming a holding company, and wherein the holding company itself acquires the insurer entity.

4. A method as claimed in claim 1, further comprising demerging the insurer entity from the sponsor entity after the writing of the one or more contracts by the sponsor entity divesting at least a portion of its ownership of the insurer entity.

5. A method as claimed in claim 4, wherein the divestment of at least a portion of the insurer entity by the sponsor entity may include:
a. offering shares or share options in the insurer entity first to shareholders of the sponsor entity;
b. offering shares in the insurer entity to investors in the market via an initial public offering or private placement;
c. the sponsor entity selling the insurer entity to a third party;
d. spinning-off the insurer entity.

6. A method as claimed in claim 1, wherein the step of writing one or more contracts includes the insurer entity writing a contract in favour of the pension scheme trustees and the wherein contract represents a buy-in in respect of selected pension scheme benefits.

7. A method as claimed in claim 1, wherein the step of writing one or more contracts includes the insurer entity writing respective contracts each in favour of a different pension scheme member, and wherein the contracts together represent a buy-out in respect of all of the pension scheme members.

8. A method as claimed in claim 1, wherein further comprising:
the insurer entity receiving deferred insurance premiums at intervals after the writing of the one or more contracts, to make up a deficit in the insurance premium paid initially by the pension scheme.

9. A method as claimed in claim 8, further comprising:
funding at least part of the deferred insurance premiums from returns on the pension scheme's and the sponsor entity's equity investments in the insurer entity.

10. A method as claimed in claim 1, wherein the insurer entity is a regulated insurer.

11. A method as claimed in claim 1, wherein the insurer entity is not consolidated in the financial statements of any of its equity investors.

12. A method as claimed in claim 1, wherein the method has been performed in relation to the insurer entity a plurality of times such that the insurer entity is contracted to make payments to counterparties dependent on the liabilities of a plurality of pension schemes.

13. A method as claimed in claim 12, further comprising offering shares in the insurer entity having a ring-fenced exposure to the risks of one of the plurality of pension schemes.

14. A method of transferring risk from a pension scheme having obligations to
a plurality of members, comprising:
an entity having one or more contracts written in favour of a counterparty to make payments dependent on the liabilities to the pension scheme members;
operating data processing apparatus to calculate the liabilities to one or more of the plurality of members and to cause an electronic payment of an amount dependent on the calculated liabilities to be executed to the counterparty;
wherein the entity is a subsidiary insurer entity of a sponsor entity of the pension scheme;
the method further comprising demerging the subsidiary insurer entity from the sponsor entity.
